(19) United States
(12) Patent Application Publication
(10) Pub. No.: US 2025/0377941 A1
(43) Pub. Date: Dec. 11, 2025

(54) EXECUTION OF API-BASED TASKS USING GENERATIVE AI

(71) Applicant: SAP SE, Walldorf (DE)

(72) Inventors: Riswan LATHIF, Munich (DE); Matthias SCHNEIDER, Munich (DE); Mathis BOERNER, Berlin (DE)

(21) Appl. No.: 18/739,589

(22) Filed: Jun. 11, 2024

(51) Int. Cl. G06F 9/50

(52) U.S. Cl. CPC G06F 9/5027

(57) ABSTRACT

Systems and methods include reception of a natural language query of a data source, generation of a first prompt to prompt determination of a plan to respond to the query, receiving the plan from a text generation model in response to the first prompt, generation of a second prompt to prompt determination of an API call and a parsing instruction, the second prompt including the plan, reception of the API call and the parsing instruction from the model in response to the second prompt, reception of a response to the API call from the data source, generation of a third prompt to prompt determination of a parsed response, the third prompt including the response and the parsing instruction, reception of the parsed response from the model in response to the third prompt, and determination of an answer to the query based on the parsed response.

### BACKGROUND

Today's organizations collect and store large sets of data at an ever-increasing rate. Data analysis tools attempt to assist humans in efficiently understanding and using such data. For example, data analysis tools may be used for planning, forecasting and discovering potentially-useful patterns based on data stored in databases, data warehouses, or other data sources.

Unfortunately, the average user does not possess the skills needed to perform sophisticated analyses using such data analysis tools. The user interfaces of these tools are often overwhelmingly complex and use thereof may require knowledge of data structures, query syntax, etc. As a result, the tools may hinder the retrieval of even basic organizational data.

A data source may implement an Application Programming Interface (API) which provides external applications with access to stored data. An API specification describes function calls provided by the API, including their parameters, example parameter values, and example usages. Theoretically, a user may access data of a data source directly via these function calls, after determining which functions to use and how to use them in order to obtain the desired result. The difficulty of this task is exacerbated in a case that a particular desired result requires the use of more than one function call. A typical end-user is therefore unable to directly utilize an API exposed by a data source to obtain a desired result.

Systems are desired to facilitate user interaction with data of a data source.

### BRIEF DESCRIPTION OF THE DRAWINGS

FIG. 1 is a block diagram of an architecture to generate an answer to a user query by determining and executing API calls according to some embodiments.

FIGS. 2A and 2B comprise a flow diagram of a process to generate an answer to a user query by determining and executing API calls according to some embodiments.

FIG. 3 is a user interface for creating a natural language query according to some embodiments.

FIG. 4 illustrates generation of a plan based on a user query and an API specification according to some embodiments.

FIG. 5 illustrates execution of a plan including API calls and responses according to some embodiments.

FIG. 6 is a user interface presenting an answer to a user query according to some embodiments.

FIG. 7 is a sequence diagram illustrating generation of an answer to a user query by determining and executing API calls according to some embodiments.

FIG. 8 is a block diagram of a hardware environment to generate an answer to a user query by determining and executing API calls according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments perform one or more CRUD (CREATE, READ, UPDATE and DELETE) operations on a data source to determine an answer to a user query, without requiring the user to interact with a complex user interface. The user query may comprise a natural language query. The data source may comprise, for example, an Enterprise Resource Planning (ERP) system.

Embodiments determine, generate and execute API calls to provide an answer to a user query. Embodiments may utilize a Large Language Models (LLM) and an API of an underlying data source to determine a plan based on a user query. Embodiments may further utilize an LLM to determine an API call and parsing instructions based on the plan, execute the API call, use an LLM to parse the response to the API calls, and use an LLM to determine a next API call and parsing instructions based on the plan and the parsed response. Determination and execution of API calls continues in this manner until the LLM responds with an answer to the user query.

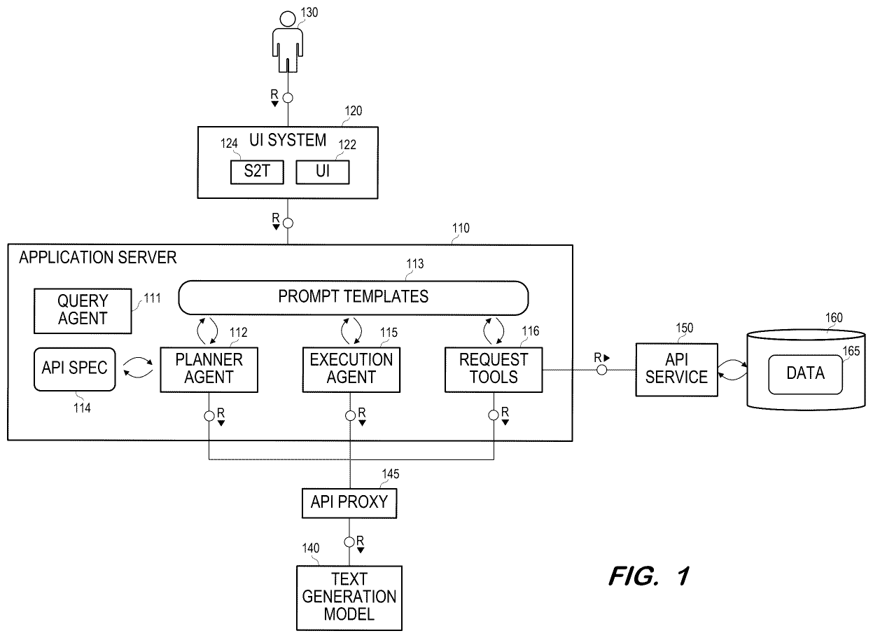

FIG. 1 is a block diagram of an architecture to generate an answer to a user query by determining and executing API calls according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric.

Application server 110 may comprise one or more servers, virtual machines, clusters of a container orchestration system, etc. Application server 110 may provide an operating system, services, I/O, storage, libraries, frameworks, etc. to applications executing therein. Agents 111, 112, 115 and tools 116 may comprise program code executable by application server 110 to operate as described herein.

For example, query agent 111 may receive natural language queries from UI system 120. UI system 120 may comprise a user device such as but not limited to a laptop computer, a desktop computer, a smartphone, and a tablet computer UI system 120 includes one or more processing units to execute program code of UI 122 and speech-to-text component 124.

UI 122 may comprise a Web browser or another application providing user interfaces for interacting with query agent 111. UI 122 may comprise a front-end UI application corresponding to query agent 111 which executes within a virtual machine of a Web browser to communicate with query agent 111 and present user interfaces thereof. User 130 may interact with such a user interface (e.g., using a keyboard and/or pointing device of system 120) to input a natural language query (e.g., “What is the quantity of Production Order 100000?”) for submission to query agent 111. According to some embodiments, user 130 speaks a natural language query, which is detected by a microphone of UI system 120, converted to text by speech-to-text component 124 and used to populate a user interface.

Query agent 111 forwards the received user query to planner agent 112. Query agent 111 may perform authorization, syntax and/or logical checks on the user query prior to transmission to planner agent 112. Planner agent 112 operates to generate a plan for answering the query based on the query, one of prompt templates 113, and API specification 114.

API specification 114 includes information of one or more APIs, each of which may be associated with to one or more endpoints (i.e., URLs) and one or more methods (e.g., GET, POST, PATCH DELETE). For each HTTP method corresponding to a URL, API specification 114 may include a description, parameters, and authentication method.

The information of API specification 114 may be curated from one of more verbose API specifications to include no more than what is needed for suitable performance of the FIG. 1 system. For example, a Production Order API specification may include many fields, most of which are unlikely to be used in a particular implementation. API specification 114 may therefore include a projection/subset of the Production Order API needed to perform desired calls.

According to some embodiments, planner agent 112 identifies one of prompt templates 113 which describes the role of planner agent 112 and populates the prompt template with the user query and with information from API specification 114. Planner agent 112 then provides the prompt to trained text generation model 140 via API proxy 145.

Text generation model 140 may comprise a neural network trained to generate text based on input text. Text generation model 140 may be implemented by, for example, executable program code, a set of hyperparameters defining a model structure and a set of corresponding weights, or any other representation of an input-to-output mapping which was learned as a result of the training. According to some embodiments, model 140 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 140 include GPT-4, LaMDA, Claude or the like. Model 140 may be publicly available or deployed within a landscape which is trusted by a provider of application server 110. Similarly, text generation model 140 may be trained based on public and/or private data. According to some embodiments, model 140 is pre-trained with API information to improve the quality of its responses to planner agent 112.

Text generation model 140 generates a plan based on the prompt received from planner agent 112. The response may comprise, in natural language, steps of a plan to generate an answer to the user query. Using the above user query as an example, model 140 may generate and return the following plan according to some embodiments: 1) Establish a secure session with the ERP system; 2) Send an empty read query to fetch the X CSRF token from the ERP system; 3) Read the response and identify the CSRF token; 4) Set the CSRF token in the header of subsequent requests; 5) Send a read request to the API with Production Order Id as 10000; 6) Read the response and extract the value of the field ‘Quantity’; and 7) Return the response to the user.

Planner agent 112 provides the plan to execution agent 115. Execution agent 115 selects one of prompt templates 113 intended to prompt determination of an answer to the user query or determination of an API call and a parsing instruction. Execution agent 115 populates the prompt template with the plan and with description of available tools (e.g., HTTP methods) and provides the populated prompt to trained text generation model 140 via API proxy 145. Execution agent 115 may, in some embodiments, utilize a text generation model which is different from the text generation model used by planner agent 112.

Text generation model 140 generates and returns an API call (e.g., a URL, a method and parameters) and a parsing instruction. Execution agent 115 passes the API call and the parsing instruction to request tools 116. In response, request tools 116 fire the API call to API service 150, which is associated with the URL of the call. API service 150 may comprise an OData service of an ERP system but embodiments are not limited thereto. Data 165 may comprise tabular data stored in a columnar or row-based format, object data or any other type of data that is or becomes known. Data store 160 may comprise any suitable storage system such as database system, which may be partially or fully remote from application server 110, and may be distributed as is known in the art. API service 150 performs the task requested by the call on data 165 of data store 160 and returns a response to request tools 116.

Request tools 116 identifies one of prompt templates 113 which is intended to prompt determination of a parsed response. Request tools 116 then populates the identified prompt template 113 with the response receive from service 150 and with the parsing instruction received from execution agent 115 and transmits the populated prompt to text generation model 140 via API proxy 145. Request tools 116 may utilize a text generation model which is different from the text generation model used by planner agent 112 and/or execution agent 115. Text generation model 140 generates a parsed response based on the prompt and returns the parsed response to tools 116, which passes the parsed response to execution agent 115.

Execution agent 115 adds the parsed response to its previously-populated prompt template and provides the new prompt to trained text generation model 140 via API proxy 145. The above exchange between execution agent 115 and request tools 116 continues until execution agent 115 receives an answer to the user query from model 140 in response to a newly-populated prompt.

The received answer is returned to UI 122 via query agent 111. UI 122 presents the answer to user 130. User 130 may then input a related or follow-up natural language query, in response to which the above process repeats. Embodiments may thereby simplify the process of interacting with data systems.

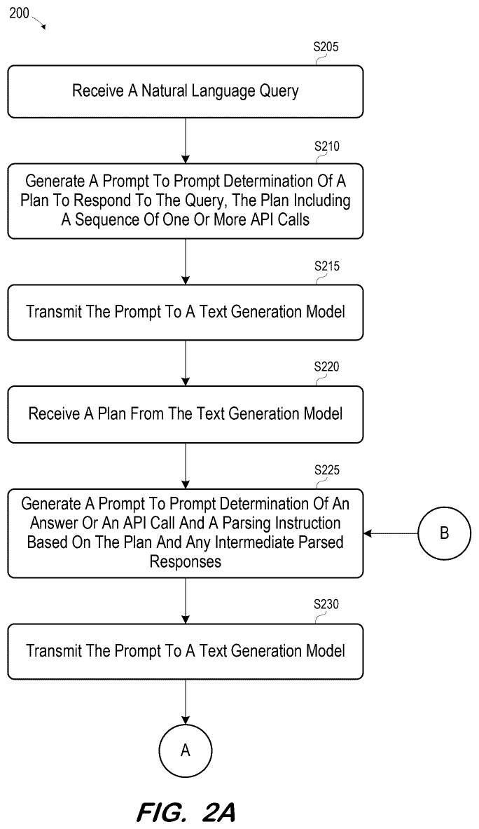

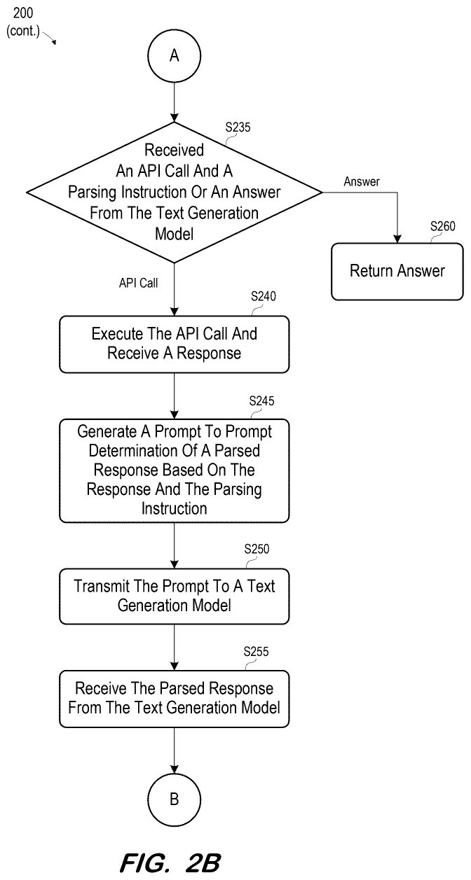

FIGS. 2A and 2B comprise a flow diagram of process 200 generate an answer to a user query by determining and executing API calls according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

A natural language query is received at S205. The natural language query may be created by a user in any suitable manner. A user may, for example, input the natural language query into an application UI and instruct the application to answer the query.

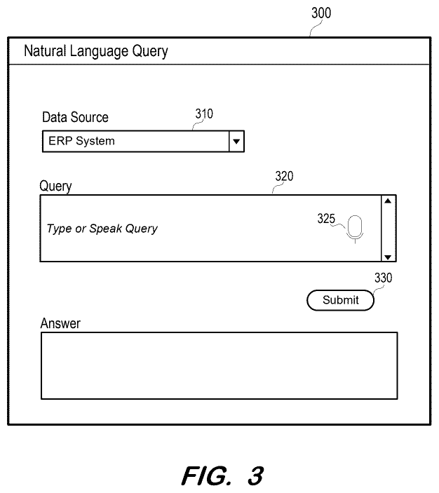

FIG. 3 illustrates user interface 300 of an application according to some embodiments. In one example, user 118 executes a Web browser to access user agent 111 via HTTP and to receive user interface 300 in return. User interface 300 includes drop-down field 310 for selecting a data source to be queried. User selection of a data source is not required according to some embodiments, for example because query agent 111 is configured for use with a one or more particular data sources.

Area 320 receives the natural language query, via typing, speech, etc. For example, user selection of icon 325 initiates speech-to-text functionality for populating area 320 using speech. Submit control 330 is selected to transmit the query to query agent 111 and to cause process 200 to proceed to S210.

A prompt is generated at S210. The prompt is intended to prompt determination of calculation components from the description based on the description and the metadata. According to some embodiments of S210, a planner agent identifies a prompt template and populates the prompt template with the user query and with information from an API specification. As mentioned above, the API specification may be curated to limit its size and unnecessary language.

One non-exhaustive example of a prompt template used to generate a prompt at S210 is as follows, in which {apis} and {query} are populated at S210 with the API specification and the received user query, respectively:

```
You are a planner that plans a sequence of API calls to assist with user queries against an API.
  You should:
  1) evaluate whether the user query can be solved by the API documentated below. Return an empty plan.
  2) if yes, generate a plan of API calls and describe what the calls are doing step by step.
  3) If the plan includes a DELETE call, you should always return an ask from the User for authorization
first unless the User has specifically asked to delete something.
  You should only use API endpoints documented below (″APIs with their endpoints you can use.″).
  You can only use the DELETE tool if the User has specifically asked to delete something. Otherwise, you
should return a request authorization from the User first.
  Some user queries can be resolved in a single API call, but some will require several API calls. Only one
call per step!
  The plan will be passed to an API controller that can format it into web requests and return the responses.
  ----
  Here are some examples:
  ‘‘‘
  Fake endpoints for examples:
  API: ‘SHOPPING_API‘
  ---
  - ‘GET /user‘: to get information about the current user
  - ‘GET /products‘: search across products
  - ‘POST /users/{{id}}/cart‘: to add products to a user's cart
  - ‘PATCH /users/{{id}}/cart‘: to update a user's cart
  - ‘DELETE /users/{{id}}/cart‘: to delete a user's cart
  User query: tell me a joke
  Plan:
  {{″steps″: [ ]}}
  User query: I want to buy a couch
  Plan:
  {{″steps″: [
    {{″description″: ″Retrieve products with a query param to search for couches″,
      ″api″: ″SHOPPING_API″,
      ″endpoint″: ″GET /products″}},
    {{″description″: ″Find the user's id″,
      ″api″: ″SHOPPING_API″,
      ″endpoint″: ″GET /user″}},
    {{″description″: ″Add a couch to the users's cart″,
      ″api″: ″SHOPPING_API″,
      ″endpoint″: ″POST /users/{{id}}/cart″}}
  ]}}
  User query: I want to add a lamp to my cart
  Plan:
  {{″steps″: [
    {{″description″: ″Retrieve products with a query param to search for lamps″,
      ″api″: ″SHOPPING_API″,
      ″endpoint″: ″GET /products″}},
    {{″description″: ″Find the user's id″,
      ″api″: ″SHOPPING_API″,
      ″endpoint″: ″GET /user″}},
    {{″description″: ″Add a lamp to the users's cart″,
      ″api″: ″SHOPPING_API″,
        ″endpoint″: ″POST /users/{{id}}/cart″}}
  ]}}
  User query: I want to delete my cart
  Plan:
  {{″steps″: [
    {{″description″: ″Find the user's id″,
      ″api″: ″SHOPPING_API″,
      ″endpoint″: ″GET /user″}},
    {{″description″: ″Delete required. Did user specify DELETE or previously authorized? Yes, proceed″,
      ″api″: null,
      ″endpoint″: null}},
    {{″description″: ″Delete the user's cart″,
      ″api″: ″SHOPPING_API″,
      ″endpoint″: ″DELETE /users/{{id}}/cart″}}
  ]}}
  User query: I want to start a new cart
  Plan:
  {{″steps″: [
    {{″description″: ″Find the user's id″,
      ″api″: ″SHOPPING_API″,
      ″endpoint″: ″GET /user″}},
    {{″description″: ″Delete required. Did user specify DELETE or previously authorized? No, ask for
authorization″,
      ″api″: null,
      ″endpoint″: null}},
    {{″description″: ″Are you sure you want to delete your cart?″,
      ″api″: null,
      ″endpoint″: null}}
  ]}}
  ‘‘‘
  ----
  APIs with their endpoints you can use. Do not reference any of the endpoints above.
  {apis}
  ----
  User query: {query}
```

The prompt generated at S210 is provided to a text generation model at S215. The text generation model generates a plan based on the prompt and the plan is received therefrom at S220. In one example, in response to a prompt including the user query “Update the quantity of Production Order 100000 to 10”, the following plan is received at S220: 1) Establish a secure session with the ERP system; 2) Send an empty read query to fetch the X CSRF token from the ERP system; 3) Read the response and identify the X CSRF token and the etag values; 4) Set X CSRF token and etag value in the request header; 5) Perform a “PATCH” request with the updated quantity in the request body; 6) Read the response from the ERP system; 7) If the request was successful—display a success message to the user; and 8) If the request failed—display a failure message to user with the reason for failure and rollback all changes.

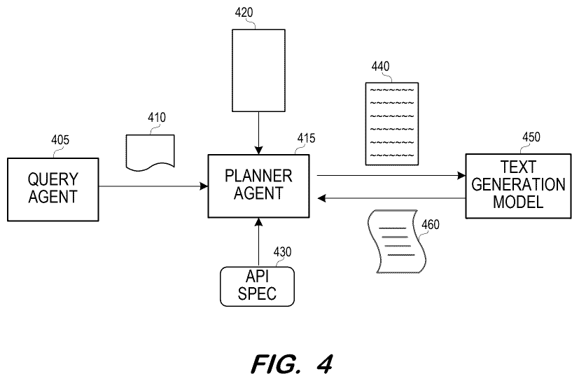

FIG. 4 illustrates execution of S205-S220 according to some embodiments. As illustrated, query agent 405 provides user query 410 to planner agent 415. Planner agent 415 populates prompt template 420 with user query 405 and API specification 430 to generate prompt 440. Prompt 440 is transmitted to text generation model 450 and model 450 generates plan 460 and returns plan 460 to planner agent 415.

Returning to process 200, a prompt is generated at S225 based on the plan. The prompt is intended to prompt determination of an answer to the user query or determination of an API call and a parsing instruction. One non-exhaustive example of a prompt template used to generate a prompt at S225 is as follows:

```
    Respond to the human as helpfully and accurately as possible. You are an agent that gets a sequence of
API calls and given their documentation, should execute them and return the final response. For execution
your are given the needed tools/functions.
    If you cannot complete them and run into issues, you should explain the issue. If you're able to resolve
an API call, you can retry the API call. When interacting with API objects, you should extract ids for inputs
to other API calls but ids and names for outputs returned to the User.
    Start of the conversation is a query by the user and the plan that you have to execute.
    Your response should always follow the pattern shown below. You in your response you have to fill ...
with actual output. Text in [ ] is to explain what kind of output is expected.
    --- start: response format in case of an action---
    Thought: ... [Your though on what to do next]
    Action:
    ‘‘‘
    ... [$JSON_BLOB describing the next action]
    ‘‘‘
    Observation: [always finish with ″Observation″ to trigger the execution of the action and to see the
result]
    --- end: response format in case of an action---
    --- start: response format to provide the final answer---
    Thought: ... [Your though on what to do next]
    Final Answer: the final answer to the original input question
    --- end: response format to provide the final answer---
    You have access to the following tools:
    {tools}
    Use a json blob to specify a tool by providing an action key (tool name) and an action_input key (tool
input).
    Valid ″action″ values: {tool_names}
    Provide only ONE action per $JSON_BLOB, as shown:
    --- start: $JSON_BLOB ---
    {{
      ″action″: $TOOL_NAME,
      ″action_input″: $INPUT
    }}
    --- end: $JSON_BLOB ---
    To recap follow this format:
    --- start: recap ---
    User Query: ... [input query to answer]
    Plan: ... [Plan to solve the query]
    Thought: consider previous and subsequent steps
    Action:
    ‘‘‘
    $JSON_BLOB
    ‘‘‘
    Observation: ... [Result of the action]
    ... [repeat Thought/Action/Observation N times]
    Thought: I know what to respond
    Final Answer: ... [The final answer to return the result of exeucting the to plan to answer the original
input. This is the only way to finish the conversation. ″Action:‘‘‘{″action″: ″Final Answer″} ... ″ is not a
valid action!].
    --- end: recap ---
    Begin! Reminder to ALWAYS respond with a valid json blob when using ″Action:″ or using ″Final
Answer:″.
    Respond directly if appropriate. Format is Thought: ... Action:‘‘‘$JSON_BLOB‘‘‘then Observation: or
Thought: ... Final Answer: ... to
  - Human: |
    User Query: {input}
    Plan: {plan}
    {agent_scratchpad}
    (reminder to respond in a JSON blob no matter what)
```

In some embodiment, {tools}, {tool_names}, {input} and {plan} are populated at S225 with descriptions of one or more usable HTTP methods, names of the HTTP methods, the user query, and the received plan, respectively. The {agent_scratchpad} placeholder is initially left blank, and its usage will become evident from the description below. A tool description for populating {tools} may be as follows:

```
get_tool
  Use this to GET content from a website.
  Input to the tool should be a json string with 3 keys: “url”, “params” and “output_instructions”.
  The value of “url” should be a string.
  The value of “params” should be a dict of the needed and available parameters from the OpenAPI spec
related to the endpoint.
  If parameters are not needed, or not available, leave it empty.
  The value of “output_instructions” should be instructions on what information to extract from the
response,
  for example the id(s) for a resource(s) that the GET request fetches
```

The populated prompt is transmitted to a text generation model at S230. In the present example, text generation model 140 generates and returns an API call (e.g., a URL, a method and parameters) and a parsing instruction. Accordingly, flow proceeds from S235 to S240. At S240, the API call is transmitted to an API service for execution and a response is received.

Next, at S245, a prompt is generated to prompt determination of a parsed response. The prompt includes both the response received at S240 and the parsing instruction received at S235. One example of such a prompt is shown below, with {request}, {response} and {instructions} to be populated with the API call, the response and the parsing instruction, respectively, at S245:

I used the following request:
‘‘‘
{request}
‘‘‘
and the API gave me this response:
‘‘‘
{response}
‘‘‘
====
Your task is to extract some information according to these instructions: {instructions}
When working with API objects, you should usually use ids over names.
If the response indicates an error, you should instead output a summary of the error.
Also consider the request when parsing the response.

The populated prompt is transmitted to a text generation model at S250, and a parsed response is received therefrom at S255. Flow then returns to S225 to generate a prompt as described above. The prompt generated at this iteration of S225 is identical to the prompt generated at the previous iteration but for the substitution to the {agent_scratchpad} placeholder with the parsed response received at S255.

The prompt is provided to the text generation model at S230 and it is determined at S235 whether the text generation model returns an answer or an API call and parsing instructions. It will be assumed that an API call and parsing instructions are returned, in which case flow proceeds from S240 through S255 as described above to generate a second parsed response. Flow returns to S225 to generate a prompt which is identical to the prompt generated at the immediately-previous iteration but for the addition of the second parsed response.

Flow continues as described above until it is determined at S235 that the text generation model has returned an answer to the user query. The answer is returned to the user at S260.

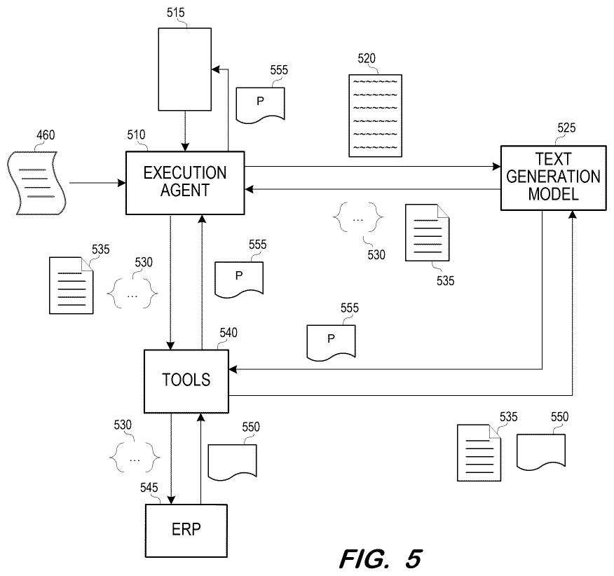

FIG. 5 illustrates S225 through S255 according to some embodiments of process 200. As shown, execution agent 510 receives plan 460. Execution agent 510 populates prompt template 515 with plan 460 to generate prompt 520. Prompt 520 is received by text generation model 525, which generates API call 530 and parsing instructions 535 based on prompt 520.

Execution agent 510 transmits API call 530 and parsing instructions 535 to tools 540. Tools 540 fires API call 530 against ERP system 545 and receives response 550 in response. Tools 540 then transmits a prompt including response 550 and parsing instructions 535 to model 525. Model 525 returns parsed response 555 to tools 540.

Tools 540 returns parsed response 555 to execution agent 510. Execution agent 510 generates another prompt 520, which is similar to the last prompt 520 but which also includes parsed response 555. Execution agent 510 transmits new prompt 520 to model 525. If text generation model 525 returns a new API call 530 and parsing information 535, the process then continues as described above. If model 525 returns an answer, the answer is passed back to the user from whom the user query was received.

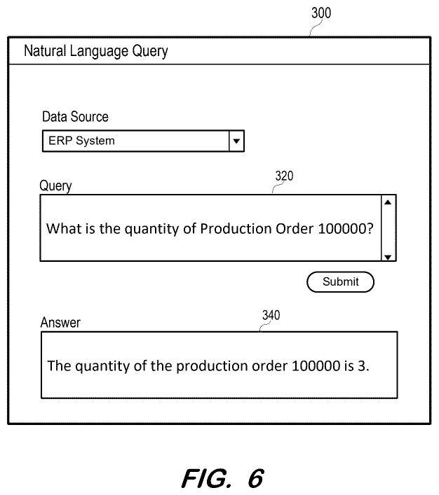

FIG. 6 shows interface 300 of FIG. 3 with an answer to the user query of area 320 presented in area 340. Embodiments may thereby allow a typical end-user to efficiently receive desired information from a data source.

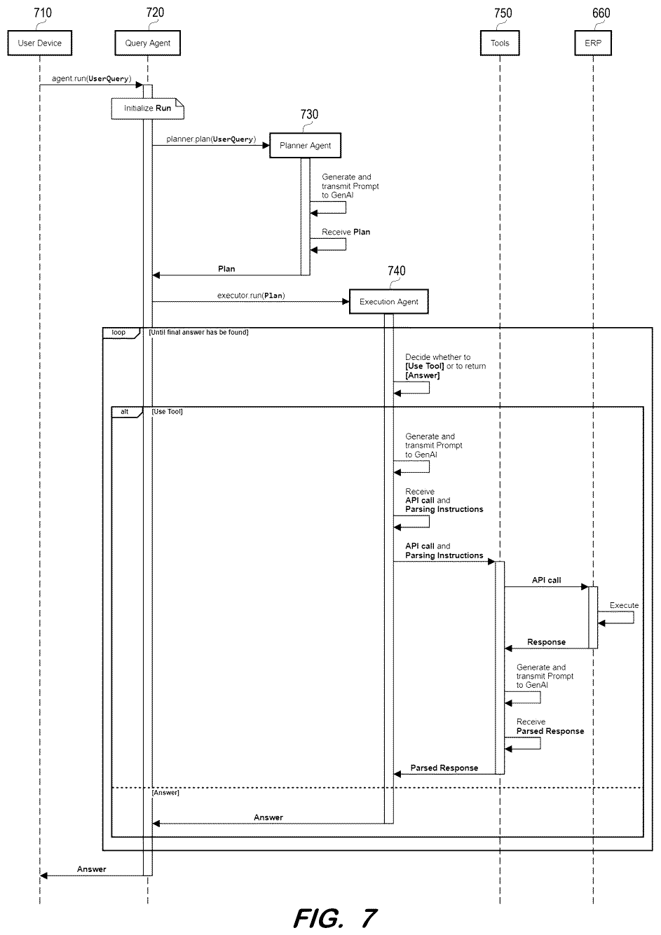

FIG. 7 is a sequence diagram illustrating generation of an answer to a user query by determining and executing API calls according to some embodiments. As illustrated, user device 710 calls query agent 720 with a user query 410. Query agent 720 then calls planner agent 730 with the user query. Planner agent 730 generates a prompt using the user query 405 and an API specification, transmits the prompt to a text generation model (e.g., a generative AI model) and receives a generated plan therefrom.

Planner agent 730 returns the plan to query agent 720. Query agent 720 then calls execution agent 740 to pass the plan thereto. Execution agent 740 generates a prompt template including the plan, and uses the prompt to obtain an API call and parsing instructions from a text generation model.

Execution agent 740 transmits the API call and the parsing instructions to tools 750. Tools 750 fires the API call against ERP system 760 and receives a response therefrom. Tools 750 then transmits a prompt including the response and the parsing instructions to a text generation model to acquire a parsed response. Execution agent 740 generates another prompt including the parsed response and transmits the new prompt to the text generation model. If the text generation model returns a new API call and parsing information, the process then continues as described above. If model returns an answer, the answer is passed back to user device 710 via query agent 720.

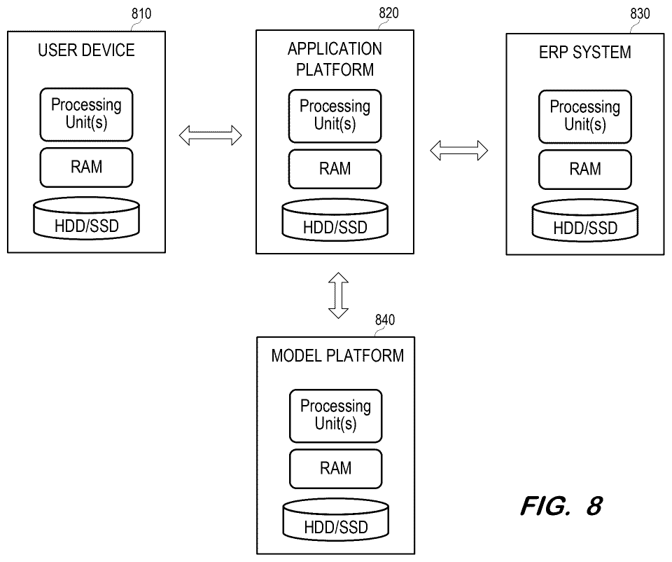

FIG. 8 is a block diagram of a cloud-based system according to some embodiments. Application platform 820, ERP system 830 and model platform 840 may each comprise cloud-based resources, such as virtual machines, allocated by a cloud provider providing self-service and immediate provisioning, autoscaling, security, compliance and identity management features.

User device 810 may interact with a user interface of an application executing on application platform 820, for example via a Web browser executing on user device 810, to input a natural language query. Application platform 820 may issue calls to model platform 840 and ERP system 830 as described herein to generate an answer to the user query.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
one or more processing units to execute the program code to cause the system to:
receive a natural language query of a data source;
generate a first prompt to prompt determination of a plan to respond to the query;
transmit the first prompt to a text generation model;
receive the plan from the text generation model in response to the first prompt;
generate a second prompt to prompt determination of an application programming interface (API) call and a parsing instruction, the second prompt including the plan;
transmit the second prompt to the text generation model;
receive the API call and the parsing instruction from the text generation model in response to the second prompt;
transmit the API call to the data source;
receive a response to the API call from the data source;
generate a third prompt to prompt determination of a parsed response, the third prompt including the response and the parsing instruction;
transmit the third prompt to the text generation model;
receive the parsed response from the text generation model in response to the third prompt; and
determine an answer to the query based on the parsed response.

2. The system of claim 1, wherein the first prompt includes the query and an API specification.

3. The system of claim 2, wherein the plan includes a sequence of two or more API calls.

4. The system of claim 1, wherein determination of an answer to the query based on the parsed response comprises:
generate a fourth prompt including the plan and the parsed response;
transmit the fourth prompt to the text generation model; and
receive the answer from the text generation model in response to the fourth prompt.

5. The system of claim 4, wherein the fourth prompt comprises the second prompt and the parsed response.

6. The system of claim 1, wherein determination of an answer to the query based on the parsed response comprises:
generate a fourth prompt to prompt determination of a second application programming interface API call and a second parsing instruction, the fourth prompt including the plan and the parsed response;
transmit the fourth prompt to the text generation model;
receive the second API call and the second parsing instruction from the text generation model in response to the fourth prompt;
transmit the second API call to the data source;
receive a second response to the second API call from the data source;
generate a fifth prompt to prompt determination of a second parsed response, the fifth prompt including the second response and the second parsing instruction;
transmit the fifth prompt to the text generation model;
receive the second parsed response from the text generation model in response to the fifth prompt; and
generate a sixth prompt including the plan, the parsed response and the second parsed response;
transmit the sixth prompt to the text generation model; and
receive the answer from the text generation model in response to the sixth prompt.

7. The system according to claim 6, wherein the fourth prompt comprises the second prompt and the parsed response, and
wherein the sixth prompt comprises the fourth prompt and the parsed response.

8. A method comprising:
receiving a natural language query;
generating a first prompt to prompt determination of a plan to respond to the query, the plan including a plurality of steps;
transmitting the first prompt to a first text generation model;
receiving the plan from the first text generation model in response to the first prompt;
generating a second prompt to prompt determination of an application programming interface (API) call and a parsing instruction, the second prompt including the plan;
transmitting the second prompt to a second text generation model;
receiving the API call and the parsing instruction from the second text generation model in response to the second prompt;
transmitting the API call to a data source;
receiving a response to the API call from a data source;
generating a third prompt to prompt determination of a parsed response, the third prompt including the response and the parsing instruction;
transmitting the third prompt to a third text generation model;
receiving the parsed response from the third text generation model in response to the third prompt; and
determining an answer to the query based on the parsed response.

9. The method of claim 8, wherein the first prompt includes the query and an API specification.

10. The method of claim 9, wherein the plan includes a sequence of two or more API calls.

11. The method of claim 8, wherein determining an answer to the query based on the parsed response comprises:
generating a fourth prompt including the plan and the parsed response;
transmitting the fourth prompt to the second text generation model; and
receiving the answer from the second text generation model in response to the fourth prompt.

12. The method of claim 11, wherein the fourth prompt comprises the second prompt and the parsed response.

13. The method of claim 8, wherein determining an answer to the query based on the parsed response comprises:
generating a fourth prompt to prompt determination of a second application programming interface API call and a second parsing instruction, the fourth prompt including the plan and the parsed response;
transmitting the fourth prompt to the second text generation model;
receiving the second API call and the second parsing instruction from the second text generation model in response to the fourth prompt;
transmitting the second API call to the data source;
receiving a second response to the second API call from the data source;
generating a fifth prompt to prompt determination of a second parsed response, the fifth prompt including the second response and the second parsing instruction;
transmitting the fifth prompt to the third text generation model;
receiving the second parsed response from the third text generation model in response to the fifth prompt; and
generating a sixth prompt including the plan, the parsed response and the second parsed response;
transmitting the sixth prompt to the second text generation model; and
receiving the answer from the second text generation model in response to the sixth prompt.

14. The method according to claim 13, wherein the fourth prompt comprises the second prompt and the parsed response, and
wherein the sixth prompt comprises the fourth prompt and the parsed response.

15. One or more non-transitory computer-readable media storing program code that, when executed by a computing system, causes the computing system to perform operations comprising:
receiving a natural language query of a data source;
generating a first prompt to prompt determination of a plan to respond to the query;
receiving the plan from a text generation model in response to the first prompt;
generating a second prompt to prompt determination of an application programming interface (API) call and a parsing instruction, the second prompt including the plan;
receiving the API call and the parsing instruction from the text generation model in response to the second prompt;
receiving a response to the API call from the data source;
generating a third prompt to prompt determination of a parsed response, the third prompt including the response and the parsing instruction;
receiving the parsed response from the text generation model in response to the third prompt; and
determining an answer to the query based on the parsed response.

16. The one or more non-transitory computer-readable media of claim 15, wherein the first prompt includes the query and an API specification, and wherein the plan includes a sequence of two or more API calls.

17. The one or more non-transitory computer-readable media of claim 15, wherein determining an answer to the query based on the parsed response comprises:
generating a fourth prompt including the plan and the parsed response; and
receiving the answer from the text generation model in response to the fourth prompt.

18. The one or more non-transitory computer-readable media of claim 17, wherein the fourth prompt comprises the second prompt and the parsed response.

19. The one or more non-transitory computer-readable media of claim 14, wherein determining an answer to the query based on the parsed response comprises:
generating a fourth prompt to prompt determination of a second application programming interface API call and a second parsing instruction, the fourth prompt including the plan and the parsed response;
receiving the second API call and the second parsing instruction from the text generation model in response to the fourth prompt;
receiving a second response to the second API call from the data source;
generating a fifth prompt to prompt determination of a second parsed response, the fifth prompt including the second response and the second parsing instruction;
receiving the second parsed response from the text generation model in response to the fifth prompt; and
generating a sixth prompt including the plan, the parsed response and the second parsed response; and
receiving the answer from the text generation model in response to the sixth prompt.

20. The one or more non-transitory computer-readable media according to claim 19, wherein the fourth prompt comprises the second prompt and the parsed response, and
wherein the sixth prompt comprises the fourth prompt and the parsed response.
